(19) United States
(12) Patent Application Publication
(10) Pub. No.: US 2009/0165945 A1
(43) Pub. Date: Jul. 2, 2009

(54) TOOL FOR USE IN THE MANUFACTURE OF TURBINE BUCKET SHROUD AND RELATED METHOD

(75) Inventor: Khue Molligan, Newark, DE (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 11/965,187

(22) Filed: Dec. 27, 2007

(51) Int. Cl. B29C 51/10

(52) U.S. Cl. 156/285; 425/405.2

(57) ABSTRACT

A tooling assembly for preforming a CMC composite component includes: a female tool having a substantially flat base and a pair of upstanding sides; a substantially rigid breather frame adapted to surround a preform seated in said female tool; release sheets adapted for placement above and below the preform; a breather mat adapted to overlie the release sheet placed above the preform; and a vacuum bag adapted to enclose the female tool and preform for compaction of the preform and extraction of solvents and excess air from the preform.

### BACKGROUND OF THE INVENTION

This invention relates to the manufacture of turbine components and, more specifically, to a tool for use in the preforming of a component such as a gas turbine bucket shroud.

The autoclave-compaction processing of CMC prepreg materials on a male tool is very complex. The de-bulking of prepreg materials is characterized by extracting volatiles (solvents) and excess air from a fiber-reinforced, high viscosity resin system. When external pressure is applied using vacuum bag processing, the solvents and air are drawn from the preform via the breather material, causing the fibers to nest closer together in the overall laminate thickness to decrease. Prepeg materials positioned on male tooling that consist of concave curvatures, have a tendency to buckle due to volumetric change as the radii decrease. In effect, the fibers need to shorten but have no place to go, resulting in either fiber waviness or buckling.

Similar vacuum bagging techniques are used in the polymer matrix composite industry. The compaction process in that industry, however, is for a static system, that is, where the constituents do not change during compaction. In contrast, the prepreg process used to make CMC products utilizes a dynamic compaction process where the material being compacted loses solvents.

There remains a need, therefore, for tooling used to preform CMC components that addresses the concave curvature issues associated with male molds.

### BRIEF DESCRIPTION OF THE INVENTION

This disclosure concerns the use of a low cost female tool combined with a woven mesh breather frame and a high strain vacuum bag for the preforming of a component such as a turbine blade or bucket shroud. The female tool provides outside mold line dimensional control. The high strain bagging material provides preform compaction in the corner areas where conventional bagging materials typically bridge across the laminate unless pleating is exploited. The woven mesh breather frame in combination with an overlying breather mat provide an unrestricted uniform flowpath for air and solvent removal, and optimal laminate compaction without distortion.

Accordingly, in one aspect, the present invention relates to a tooling assembly for preforming a CMC composite component comprising: a female tool having a substantially flat base and a pair of upstanding sides; a substantially rigid breather frame adapted to surround peripheral edges of a preform seated in the female tool; upper and lower release sheets adapted for placement above and below the preform; a breather mat adapted to overlie at least the preform and upper release sheet; and a vacuum bag adapted to enclose the female tool and preform for compaction of the preform and extraction of solvents and excess air from the preform.

In another aspect, the invention relates to a method of vacuum forming a CMC composite preform comprising providing a female mold; locating a first release sheet on the mold; laying up the preform on the release sheet in the female mold; surrounding peripheral edges of the preform with a porous, substantially rigid breather frame; applying a second release mat at least over the preform; applying a breather mat over the female tool, preform and second release mat; enclosing the female tool and preform within a vacuum bag; and drawing a vacuum to compact the preform and to extract volatiles and excess air through the breather frame and the breather mat.

The invention will now be described in connection with the drawings identified below.

### BRIEF DESCRIPTION OF THE DRAWINGS

FIG. 1 is a perspective view illustrating a female tool and preform in accordance with an exemplary but non-limiting implementation of the disclosed technology;

FIG. 2 is a perspective view of a woven mesh breather frame that surrounds the preform during compaction; and

FIG. 3 is a schematic cross section along the line A-A of FIG. 1, illustrating additional components used in the CMC compaction process.

### DETAILED DESCRIPTION OF THE INVENTION

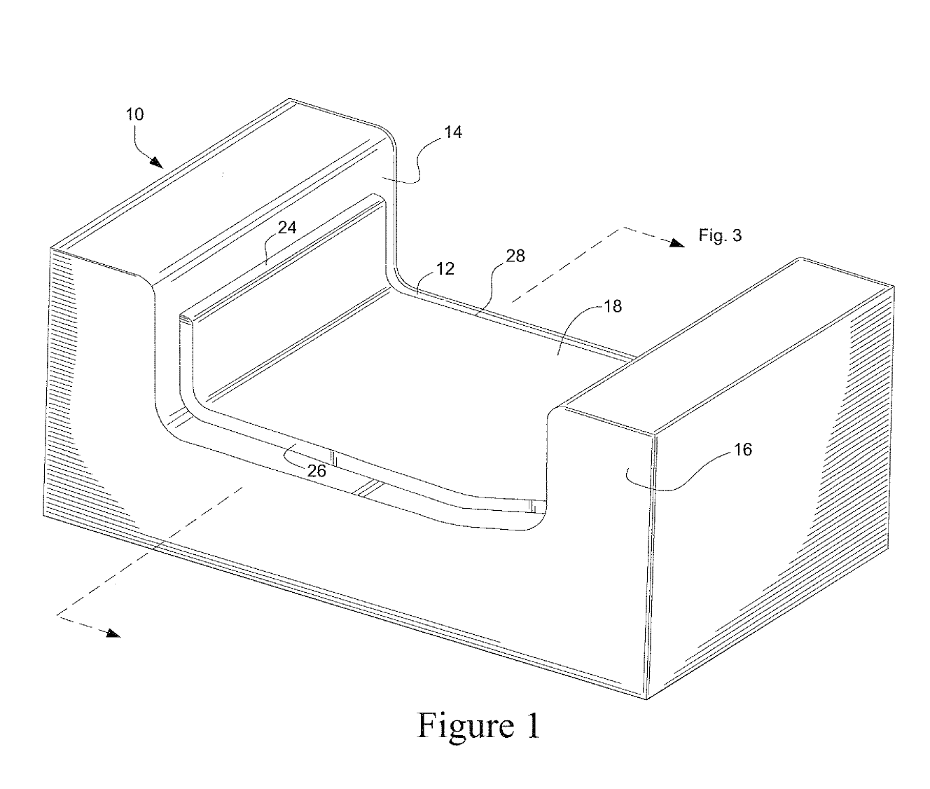

With reference to FIG. 1, a substantially U-shaped female tool 10 comprises a relatively flat base portion 12 and a pair of upstanding sides 14, 16, substantially parallel to one another. The female tool 10 is constructed of low cost plaster or ceramic castable material (e.g., graphite, aluminum or other suitable material) as understood by those skilled in the art. The shape of the tool is to a large extent dictated by the shape of the article preform (in the exemplary but non-limiting implementation, the article is a turbine blade or vane shroud of substantially U-shape).

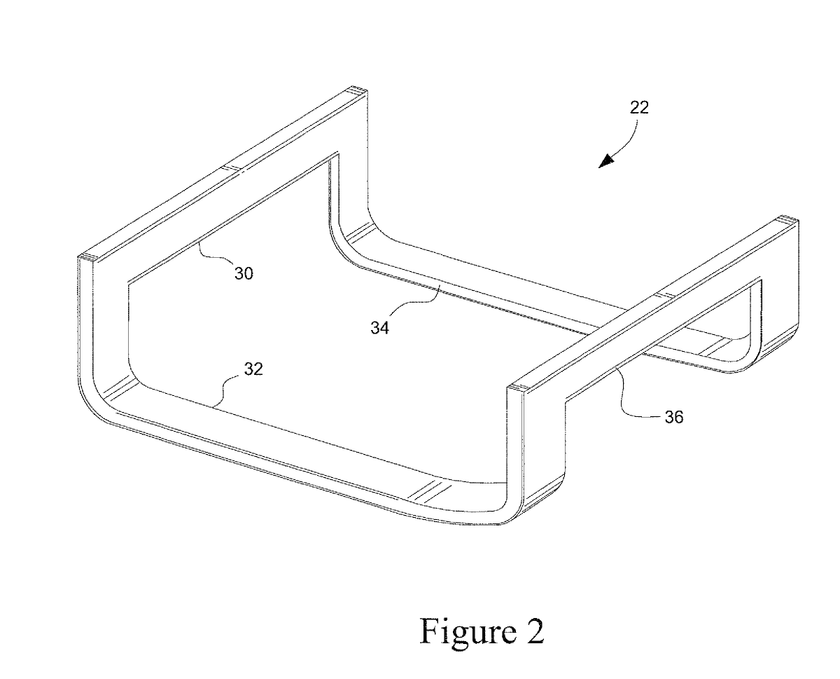

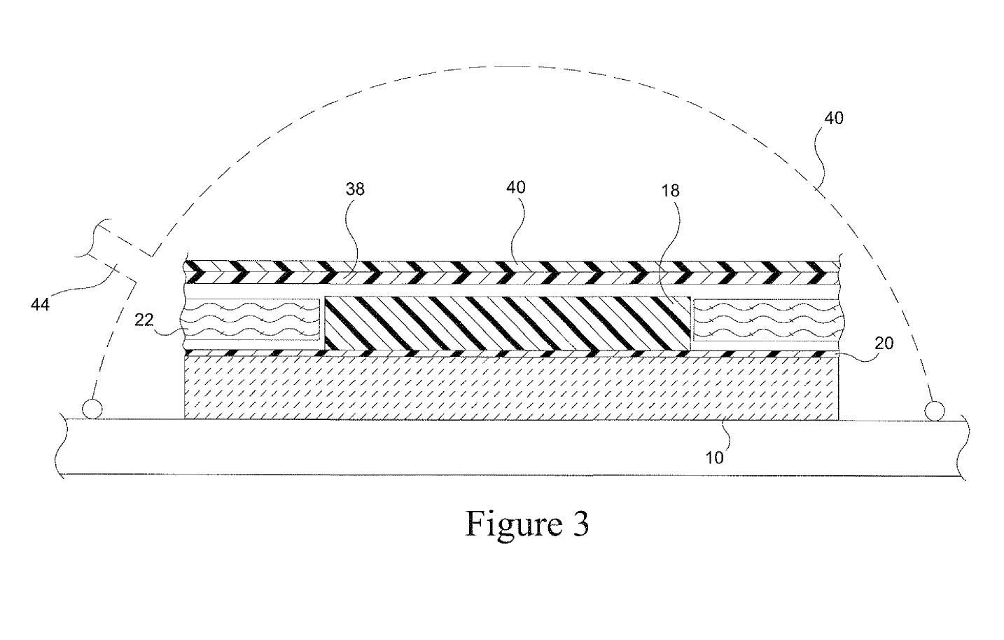

With reference also to FIG. 3, a CMC shroud preform 18 is laid up within the female tool cavity, with a release mat 20 interposed between the tool 10 and the preform 18. The mat 20 may be composed of a polytetrafluoroethylene material such as Teflon® or other suitable material. The release mat insures that the preform will not bond to the tool, allowing removal after compaction. A relatively hard porous frame 22, best seen in FIG. 2, made from a woven mesh breather medium (e.g., a rigid woven mesh Nylon material), is designed to surround the preform. The breather frame confines the preform about its four side edges, thus preventing distortion of the preform during compaction. At the same time, the porous material provides a continuous vacuum path around the perimeter of the preform, thus allowing uniform extraction of solvents and excess air from the preform. More specifically, the preform peripheral edges 24, 26, 28 and one additional edge not seen in FIG. 1, but similar to and opposite edge 24, are engaged by edges 30, 32, 34 and 36, respectively, of the breather frame. The next layer is a porous and otherwise conventional release ply 38 (FIG. 3) applied over the preform and the frame. A relatively soft, porous breather mat 40 is applied over the entire assembly and not only facilitates uniform removal of excess air and volatiles, but also prevents damage to the vacuum bag during compaction. The breather mat may be an N-10 or N-20 non-woven polyester or other suitable material. The high strain vacuum bag 42, formed with a vacuum port 44, encloses the entire tooling assembly and provides the required compaction of the perform. The entire molding assembly may be placed in any conventional heating chamber, such as an oven or an autoclave to apply the necessary heat during vacuum compaction and subsequent curing in accordance with conventional practice.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A tooling assembly for preforming a CMC composite component comprising:
a female tool having a substantially flat base and a pair of upstanding sides;
a substantially rigid breather frame adapted to surround peripheral edges of a preform seated in said female tool;
upper and lower release sheets adapted for placement above and below the preform;
a breather mat adapted to overlie at least the preform and upper release sheet; and
a vacuum bag adapted to enclose the female tool and preform for compaction of the preform and extraction of solvents and excess air from the preform.

2. The assembly of claim 1 wherein said breather frame is comprised of a woven mesh material.

3. The assembly of claim 2 wherein said woven mesh material comprises nylon.

4. The assembly of claim 1 wherein said upper and lower release sheets are comprised of polytetrafluoroethylene.

5. The assembly of claim 1 wherein said female tool is comprised of a plaster or ceramic castable.

6. A method of vacuum forming a CMC composite preform comprising providing a female mold;
locating a first release sheet on the mold;
laying up the preform on the release sheet in the female mold;
surrounding peripheral edges of the preform with a porous, substantially rigid breather frame;
applying a second release mat at least over the preform;
applying a breather mat over the female tool, preform and second release mat;
enclosing the female tool and preform within a vacuum bag; and
drawing a vacuum to compact the preform and to extract volatiles and excess air through the breather frame and the breather mat.

7. The method of claim 6 wherein said breather frame is comprised of a woven mesh material.

8. The method of claim 6 wherein said woven mesh material comprises nylon.

9. The method of claim 6 wherein said release sheets are comprised of polytetrafluoroethylene.

10. The method of claim 6 wherein said CMC composite preform comprises a turbine bucket shroud preform.
